(19) United States
(12) Patent Application Publication
(10) Pub. No.: US 2007/0259994 A1
(43) Pub. Date: Nov. 8, 2007

(54) Elastomers Reinforced with Carbon Nanotubes

(75) Inventors: James M. Tour, Bellaire, TX (US); Jared L. Hudson, McLean, VA (US); Ramanan Kirshnamoorti, Bellaire, TX (US); Koray Yurekli, Istanbul (TR); Cynthia A. Mitchell, Houston, TX (US)

Correspondence Address: ROSS SPENCER GARSSON;WINSTEAD SECHREST & MINICK P.C., P. O. BOX 50784, DALLAS, TX, 75201, US

(73) Assignees: William Marsh Rice University, Houston, TX (US); The University of Houston, Houston, TX (US)

(21) Appl. No.: 10/561,712

(22) PCT Filed: Jun. 23, 2004
(86) PCT No.: PCT/US04/20108

§ 371 Date: Jun. 7, 2007

Related U.S. Application Data
(60) Provisional application No. 60/480,643, filed on Jun. 23, 2003.

(51) Int. Cl. C08K 7/06; C01B 31/02

(52) U.S. Cl. 523/333; 524/847; 977/742

(57) ABSTRACT

The present invention is directed to carbon nanotube-elastomer composites, methods for making such carbon nanotube-elastomer composites, and articles of manufacture made with such carbon nanotube-elastomer composites. In general, such carbon nanotube-elastomer (CNT-elastomer) composites display an enhancement in their tensile modulus (over the native elastomer), but without a large concomitant reduction in their strain-at-break.

### CROSS REFERENCE TO RELATED APPLICATIONS

This Application claims priority to United States Provisional Patent Application Ser. No. 60/480,643 filed Jun. 23, 2003.

This invention was made with support from the National Aeronautics and Space Administration, Grant Nos. NASA-JSC-NCC-9-77 and NASA TiiMS NCC-01-0203 CFDA #43.001; the National Science Foundation, Grant No. NSR-DMR-0073046; and the Air Force Office of Scientific Research, Grant No. F49620-01-0364.

### FIELD OF THE INVENTION

The present invention relates generally to elastomeric materials, and more specifically to elastomeric materials that are reinforced with carbon nanotube materials.

### BACKGROUND

Elastomers are used commercially in a wide range of applications in many market segments including rubber tires, which is the largest consumer of natural and synthetic rubber. The North American synthetic rubber industry had a volume of 2.2 million metric tons in 2002 [Tullo A H: “Synthetic Rubber,” Chem. & Eng. News 2003, 81:23]. The global market for fluoroelastomers, an important category of high-performance elastomer used in extreme environments in aerospace, automotive, chemical processing, oil and gas, and semiconductor applications, was 40,000 metric tons in 2000 with a value of $450 million in 2002 [Tullo A H: “A Renaissance in Fluoroelastomers,” Chem. & Eng. News 2002, 80:15]. DuPont Dow Elastomers LLC is the world's largest fluoroelastomers maker, with 41% of the market in 2000. Prices range from $40 to $400 per kg for these unique products that perform in conditions where no other products will suffice.

Polymer-based composites, where polymers serve as the matrix for inorganic fillers, have had significant impact as engineering materials. Filled elastomers and fiber-reinforced composites are among the most well known examples. Carbon black or glass fibers are incorporated into polymer hosts resulting in significant improvements in mechanical properties (impact strength, tensile and compressive moduli and strength, toughness) over that of the native polymer. More recently, there has been interest in making hybrid, organic-inorganic materials in which nanoscale inorganic partides, because of their large surface to volume ratios and because of the possibility of introducing synergisms not anticipated in macrocomposites, are incorporated into polymer hosts [Giannelis E P, Krishnamoorti R, Manias E: “Polymer-silicate nanocomposites: Model systems for confined polymers and polymer brushes,” Adv. Polym. Sci. 1999, 138:107-147; Giannelis E P: “Polymer Layered Silicate Nanocomposites,” Adv. Mater. 1996, 8:29]. Amongst these nanocomposites, significant enhancements in mechanical and physical properties have been observed for elastomers and thermosets filled with layered silicates and nanoscale silica and titania particles, and these enhancements have been correlated with the surface area of the inorganic material added and the extent of interfacial interaction between the cross-linkable polymer and the nanoparticles [Mark JE: “Some Simulabons on filler reinforcement in elastomers,” Molecular Crystals and Liquid Crystals 2002, 374:29-38; Hsiao B S, White H, Rafailovich M, Mather P T, Jeon H G, Phillips S, Lichtenhan J, Schwab J: “Nanoscale reinforcement of polyhedral oligomeric silsesquioxane (POSS) in polyurethane elastomer,” Polymer International 2000, 49:437-440; LeBaron P C, Wang Z, Pinnavaia T J: “Polymer-layered silicate nanocomposites: an overview,” Applied Clay Science 1999, 15:11-29; Burnside S D, Giannelis E P: “Nanostructure and properties of polysiloxane-layered silicate nanocomposites,” Journal of Polymer Science Part B-Polymer Physics 2000, 38:1595-1604].

Traditionally, additives are applied within elastomers to make them have a higher tensile modulus (stiffness), but the result is generally accompanied by a concomitant large reduction in the strain-at-break. Specifically, as a comparison, polyisoprene shows a strain-at-break of 10 (i.e., 1000%) or higher. By adding 60-80% by weight carbon black, the tensile modulus could increase 10-fold (10×), but the strain-at-break would fall to less than 3 (300%), hence it would no longer respond like an elastomer, but as a thermoplastic in its dynamic mechanical properties. The development of high strength elastomers with high breaking strains and low densities are crucial in many applications including tires, belts, hoses, seals, O-rings, blow-out preventors (BOPs), etc. that affect industries such as automotive, engine, aerospace, oil drilling and refining, etc. Therefore, any mechanism by which elastomers could be stiffened, while retaining the elongation-to-break properties, would be a significant advance.

Nanophase materials have recently shown great potential in many applications due to their unique optical, electrical, chemical, and mechanical properties. Inorganic ceramic nanomaterials in particular are being considered as strengthening agents for polymers. Nano-sized inorganic fillers can add tensile strength, stiffness, abrasion resistance, and stability to polymer networks. However, a major limitation to the use of nanomaterials in polymer composites is dispersion of hydrophilic nanoparticles in very hydrophobic polymers. Unmodified nanoparticles often aggregate in these composites and lose their nanoscale size and corresponding properties.

Carbon nanotubes, and single-walled carbon nanotubes (SWNTs) in particular, have attracted considerable attention due to their unique chemical and physical properties as well as their promise in the area of materials chemistry [Bahr J L, Tour J M: “Covalent chemistry of single-wall carbon nanotubes,” Journal of Materials Chemistry 2002, 12:1952-1958; Hirsch A: “Functionalization of single-walled carbon nanotubes,” Angewandte Chemie-International Edition 2002, 41:1853-1859; Colbert D T: “Single-wall nanotubes: a new option for conductive plastics and engineering polymers,” Plastics Additives & Compounding 2003, January/February; Baughman R H, Zakhidov A A, de Heer W A: “Carbon nanotubes—a route toward applications,” Science 2002, 297:787-792]. However, while it is an active area of research, many of the issues concerning the effective dispersion of the nanotubes in polymer matrices have yet to be completely understood and organized. SWNTs exhibit extraordinary combination of mechanical, electrical, and thermal properties [Yakobson B l, Brabec C J, Bernholc J: “Nanomechanlics of Carbon Tubes: Instabilities beyond Linear Response,” Phys. Rev. Lett. 1996, 76:2511-2514; Walters D A, Ericson L M, Casavant M J, Liu J, Colbert D T, Smith K A, Smalley R E: “Elastic Strain of Freely Suspended Single-Wall Carbon Nanotubes Ropes,” Appl. Phys. Lett. 1999, 74:3803-3805; Saito R, Dresselhaus G. Dresselhaus M S: “Physical Properties of Carbon Nanotubes,” London: Imperial College Press; 1998]. They possess tensile strengths of 50-200 GPa, estimated Young's moduli of 1-5 TPa, and high strains (˜5-6%) at break [Walters D A, Ericson L M, Casavant M J, Liu J, Colbert D T, Smith K A, Smalley R E: “Elastic Strain of Freely Suspended Single-Wall Carbon Nanotubes Ropes,” Appl. Phys. Lett. 1999, 74:3803-3805; Saito R, Dresselhaus G, Dresselhaus M S: “Physical Properties of Carbon Nanotubes,” London: Imperial College Press; 1998; Salvetat J-P, Briggs G A D, Bonard J-M, Bacsa R R, Kulik A J, Stockil T, Bumham N A, Forro L: “Elastic and Shear Moduli of Single-Walled Carbon Nanotube Ropes,” Phys. Rev. Lett. 1999, 82:944-947; Treacy M M J, Ebbesen T W, Gibson J M: Nature 1996, 381:678-680; Yu M-F, Files B S, Arepalli S, Ruoff R S: “Tensile loading of Ropes of Single Wall Carbon Nanotubes and their Mechanical Properties,” Phys. Rev. Lett. 2000, 84:5552-5555; Yu M-F, Lourie O, Dyer M J, Moloni K, Kelly T F, Ruoff R S: “Strength and Breaking Mechanism of Multiwalled Carbon Nanotubes Under Tensile Load,” Science 2000, 287:637-640; Rao A M, Richter E, Bandow S, Chase B, Williams K A, Fang S, Subbaswamy K R, Menon M, Thess A, Smalley R E: “Diameter-Selective Raman Scattering from Vibrational Modes in Carbon Nanotubes,” Science 1997, 275:187-191; Lourie O, Cox D M, Wagner H D: “Buckling and Collapse of Embedded Carbon Nanotubes,” Phys. Rev. Lett. 1998, 81:1638-1641]. Further, when released from strain, bent SWNTs recover their original form without direct fracture [Falvo M R, Clary G J, Taylor II R M, Chi V, Brooks Jr F P, Washburn S, Superfine R: “Bending and Buckling of Carbon Nanotubes under Large Strain,” Nature 1997, 389:582-584; Marco Buongiorno Nardelli, B. I. Yakobson, Bernholc J: “Mechanism of strain release in carbon nanotubes,” Phys. Rev. B 1998, 57:4277-4280]. On the basis of these extraordinary mechanical properties and the large aspect ratio associated with individual tubes (typically ˜10³), SWNTs are excellent candidates for the development of nano-reinforced polymer composite materials [Mitchell C A, Bahr J L, Arepalli S, Tour J M, Krishnamoorti R: “Dispersion of Functionalized Carbon Nanotubes in Polystyrene;” Macromolecules 2002, 35:8825-8830]. Moreover, because of their extraordinary optical, electrical and electronic properties, SWNT-based composite materials are considered to be good candidates to serve as the “active” material component in a new generation of devices [Saito R, Dresselhaus G, Dresselhaus M S: “Physical Properties of Carbon Nanotubes,” London: Imperial College Press; 1998; Strano M S, Dyke C A, Usrey M L, Barone P W, Allen M J, Shan H W, Kittrell C, Hauge R H, Tour J M, Smalley R E: “Electronic structure control of single-walled carbon nanotube functionalization,” Science 2003, 301:1519-1522].

Research on nanotube composites have concentrated, for the most part, on polymer-multiwalled nanotube (MWNT) based materials [Gong X Y, Liu J, Baskaran S, Voise R D, Young J S: “Surfactant-assisted processing of carbon nanotube/polymer composites,” Chem Mater 2000, 12:1049-1052; Jin Z, Pramoda K P, Xu G, Goh S H: “Dynamic mechanical behavior of melt-processed multi-walled carbon nanotube/poly(methyl methacrylate) composites,” Chem Phys Lett 2001, 337:43-47; Zhao Q, Wood J R, Wagner H D: “Stress fields around defects and fibers in a polymer using carbon nanotubes as sensors,” Appl Phys Lett 2001, 78:1748-1750; Wood J R, Zhao Q, Frogley M D, Meurs E R, Prins A D, Peijs T, Dunstan D J, Wagner H D: “Carbon nanotubes: From molecular to macroscopic sensors,” Phys Rev B 2000, 62:7571-7575; Qian D, Dickey E C, Andrews R, Rantell T: “Load transfer and deformation mechanisms in carbon nanotube-polystyrene composites,” Appl Phys Lett 2000, 76:2868-2870; Curran S, Davey A P, Coleman J, Dalton A, McCarthy B, Maier S, Drury A, Gray D, Brennan M, Ryder K, et al.: “Evolution and evaluation of the polymer nanotube composite,” Synthetic Metals 1999, 103:2559-2562; Lourie O, Wagner H D: “Evidence of stress transfer and formation of fracture clusters in carbon nanotube-based composites,” Composites Science and Technology 1999, 59:975-977; Wagner H D, Lourie O, Zhou X F: “Macrofragmentation and microfragmentation phenomena in composite materials,” Composites Part a-Applied Science and Manufacturing 1999, 30:59-66; Garg A, Sinnott S B: “Effect of chemical functionalization on the mechanical properties of carbon nanotubes,” Chem Phys Lett 1998, 295:273-278; Curran S A, Ajayan P M, Blau W J, Carroll D L, Coleman J N, Dalton A B, Davey A P, Drury A, McCarthy B, Maier S: “A composite from poly(m-phenylenevinylene-co-2,5-dioctoxy-p-phenylenevinylene) and carbon nanotubes: A novel material for molecular optoelectronics,” Adv Mater 1998, 10:1091; Lourie O, Wagner H D: “Evaluation of Young's modulus of carbon nanotubes by micro-Raman spectroscopy,” J Mater Res 1998, 13:2418-2422; Sinnott S B, Shenderova O A, White C T, Brenner D W: “Mechanical properties of nanotubule fibers and composites determined from theoretical calculations and simulations,” Carbon 1998, 36:1-9; Wagner H D, Lourie O, Feldman Y. Tenne R: “Stress-induced fragmentation of multiwall carbon nanotubes in a polymer matrix,” Appl Phys Lett 1998, 72:188-190; Schadler L S, Giannaris S C, Ajayan P M: “Load transfer in carbon nanotube epoxy composites,” Appl Phys Lett 1998, 73:3842-3844; Wood J R, Zhao Q, Wagner H D: “Orientation of carbon nanotubes in polymers and its detection by Raman spectroscopy,” Composites Part a-Applied Science and Manufacturing 2001, 32:391-399; Cooper C A, Young R J, Halsall M: “Investigation into the deformation of carbon nanotubes and their composites through the use of Raman spectroscopy,” Composites Part a-Applied Science and Manufacturing 2001, 32:401-411; Cooper C A, Young R J: “Investigation of structure/property relationships in particulate composites through the use of Raman spectroscopy,” Journal of Raman Spectroscopy 1999, 30:929-938]. Polymer-MWNT composites exhibit mechanical properties that are superior to conventional polymer-based composites due to their considerably higher intrinsic strength and modulus and the fact that the stress transfer efficiency can be just over an order of magnitude better in some systems [Schadler L S, Giannaris S C, Ajayan P M: “Load transfer in carbon nanotube epoxy composites,” Appl Phys Lett 1998, 73:3842-3844]. Mechanical measurements of PS-MWNTs show that 1 wt % of MWNTs increase the modulus by up to 40% [Wagner H D, Lourie O, Feldman Y, Tenne R: “Stress-induced fragmentation of multwall carbon nanotubes in a polymer matrix,” Appl Phys Lett 1998, 72:188-190]. Apart from conventional mechanical measurements of the modulus and strength, dynamical mechanical measurements (DMA) have been performed. DMA measurements reveal that 1 wt % MWNT in Bisphenol-A epoxy resin increased the elastic modulus by approximately 30% and decreased T_{g} by over 20° C. [Schadler L S, Giannaris S C, Ajayan P M: “Load transfer in carbon nanotube epoxy composites,” Appl Phys Lett 1998, 73:3842-3844]. The presence of 20 wt % MWNT in poly(methyl methacrylate) (PMMA) resulted in an increase in the elastic modulus by a factor of 2 [Jin Z X, Sun X, Xu G Q, Goh S H, Ji W: “Nonlinear optical properties of some polymer/multi-walled carbon nanotube composites,” Chem Phys Lett 2000, 318:505-510]. This increase is accompanied by only a small increase in the T_{g}. These results clearly indicate that nanotube based polymer-nanocomposites are viable engineering materials for a range of applications.

Polymer-SWNTs composites show even more promise than the MWNT based nanocomposites as potential high-performance engineering materials [Barraza H J, Pompeo F, O'Rear E A, Resasco D E: “SWNT-filled thermoplastic and elastomeric composites prepared by miniemulsion polymerization,” Nano Letters 2002, 2:797-802; Dufresne A, Paillet M, Putaux J L, Canet R, Carmona F, Delhaes P, Cui S: “Processing and characterization of carbon nanotube/poly(styrene-co-butyl acrylate) nanocomposites,” J of Materials Science 2002, 37:3915-3923; Steuerman D W, Star A, Narizzano R, Choi H, Ries R S, Nicolini C, Stoddart J F, Heath J R: “Interactions between conjugated polymers and single-walled carbon nanotubes,” J of Physical Chemistiy B 2002, 106:3124-3130; Kymakis E, Alexandou I, Amaratunga G A J: “Single-walled carbon nanotube-polymer composites: electrical, optical and structural investigation,” Synthetic Metals 2002, 127:59-62; Wei C Y, Srivastava D, Cho K J: “Thermal expansion and diffusion coefficients of carbon nanotube-polymer composites,” Nano Letters 2002, 2:647-650; Grady B P, Pompeo F, Shambaugh R L, Resasco D E: “Nucleation of polypropylene crystallization by singie-walled carbon nanotubes,” J of Physical Chemistry B 2002, 106:5852-5858; Alexandrou I, Kymakis E, Amaratunga G A J: “Polymer-nanotube composites: Burying nanotubes improves their field emission properties,” Applied Physics Letters 2002, 80:1435-1437; Kumar S, Doshi H, Srinivasarao M, Park J O, Schiraldi D A: “Fibers from polypropylene/nano carbon fiber composites,” Polymer 2002, 43:1701-1703; Liao K, Li S: “Interfacial characteristics of a carbon nanotube-polystyrene composite system,” Applied Physics Letters 2001, 79:4225-4227]. For instance, DMA studies of in situ-polymerized PMMA-SWNTs demonstrated that the tensile modulus increased by more than a factor of 5 with less than 0.1 wt % SWNT [Putz K, Mitchell C A, Krishnamoorti R, Green P F: “Elastic Modulus of Single—Walled Carbon Nanotube—PMMA Nanocomposites.” J. Polym. Sci. Part B: Polym. Phys., 2004, 42, 2286-2293]. These improvements are far in excess of that observed in the PMMA-MWNT nanocomposites. Independent experiments on PMMA-SWNTs at low nanotube concentrations indicate that the polymer is intimately mixed with the nanotubes [Benoit J M, Corraze B, Lefrant S, Blau W J, Bernier P, Chauvet O: “Transport properties of PMMA-carbon nanotubes composites,” Synthetic Metals 2001, 121:1215-1216; Stephan C, Nguyen T P, de la Chapelle M L, Lefrant S, Joumet C, Bernier P: “Characterization of singlewalled carbon nanotubes-PMMA composites,” Synthetic Metals 2000, 108:139-149]. On the other hand, measurements of the melt rheology of PS-SWNT nanocomposites Indicate a substantial increase in the viscosity and elasticity of the system at low shear rates at 1 wt % and suggesting of dispersions with effective aspect ratios for the SWNTs in excess of 100 [Mitchell C A, Bahr J L, Arepalli S, Tour J M, Krishnamoorti R: “Dispersion of Functionalized Carbon Nanotubes in Polystyrene,” Macromolecules 2002, 35:8825-8830]. While compatibility between the polymer and SWNT is necessary for improved properties, the molecular principles for effecting such changes are yet to be adequately delineated. Indeed, previous efforts to produce CNT-elastomer composites with enhanced properties have been largely unsuccessful [Frogley M D, Ravich D, Wagner H D: “Mechanical properties of carbon nanopartide-reinforced elastomers,” Composites Science & Technol. 2003, 63:1647-1654]. One would anticipate the properties would depend on a range of variables including, relative energetic interactions between the nanotubes and the polymer, concentration, configuration of the nanotubes and processing. In order to fully exploit the unique properties of polymer-SWNTs, it is imperative that an understanding and manipulability of configurations and spatial distribution of the nanotubes within the polymer host be developed.

### SUMMARY

The present invention is directed to carbon nanotube-elastomer composites, methods for making such carbon nanotube-elastomer composites, and articles of manufacture made with such carbon nanotube-elastomer composites. In general, such carbon nanotube-elastomer (CNT-elastomer) composites display an enhancement in their tensile modulus (over the native elastomer), but without a significant concomitant reduction in their strain-at-break.

In general, the methods of the present invention comprise the steps of: 1) mixing carbon nanotubes with an elastomeric precursor (i.e., a polymer capable of becoming an elastomer upon curing or vulcanization), and 2) crosslinking (i.e., curing) the mixture to make a composite and/or blend of carbon nanotubes in an elastomeric material.

Generally, the amount (i.e., wt %) of carbon nanotubes in the CNT-elastomer composite corresponds in a profound manner to the properties the CNT-elastomer composite has. These amounts, however, are dependent upon the type of CNTs used, and on any chemical modification and/or processing the CNTs have undergone. It is also dependent upon the elastomeric system employed. Suitable elastomeric systems include, but are not limited to, crosslinked versions of: poly(dimethylsiloxane) and other polysiloxanes, polyisoprene, polybutadiene, polyisobutylene, halogenated polyisoprene, halogenated polybutadiene, halogenated polyisobutylene, low-temperature epoxy, ethylene propylene diene mononomer (EPDM) terpolymers, polyacrylonitriles, acrylonitrile—butadiene rubbers, styrene butadiene rubbers, ethylene propylene and other α-olefin copolymer based elastomers, tetrafluoroethylene based, copolymers of hexafluoropropylene and vinylidene fluoride, perfluoro methyl vinyl ethers and combinations thereof.

In some embodiments, the carbon nanotubes are single-wall carbon nanotubes (SWNTs). In these or other embodiments, the carbon nanotubes may be chemically-functionalized or otherwise modified. Such chemical modification may facilitate the mixing and/or dispersion within the polymer matrix In some embodiments, chemically-modified CNTs interact chemically with the polymer matrix, and in some of these embodiments, the chemical interaction involves covalent bonding between the elastomer and the CNT or CNT-pendants. In some embodiments, CNTs are functionalized with pendant groups capable of interacting with the polymer matrix and participating in the crosslinking of the polymer matrix

In some embodiments, characterization of the dispersion states of these nanocomposites, via spectroscopy (e.g., absorption and Raman), scattering (x-ray and neutron), microscopy (force and electron) and rheological analysis, is used to evaluate the optimal nanocomposites. In some embodiments, the optimal conditions for network formation and stress transfer for poly(siloxane), polyisoprene, polybutadiene, polyisobutylene, fluoroelastomers, nitrile rubber and poly(propylene fumarate) based network structures in the presence of SWNTs using linear melt rheology, linear dynamic mechanical, differential scanning calorimetry and solvent swelling are examined using techniques such as Fourier transform infrared (FTIR), nuclear magnetic resonance (NMR), and Raman spectroscopies.

In some embodiments, the tensile and compressive properties of these filled network structures are measured, correlated and optimized over the linear and non-linear regimes until failure.

In some embodiments, single wall carbon nanotube (SWNT) based cross-linked polymer nanocomposites are prepared, thereby exploiting the dramatic mechanical properties of SWNTs while only slightly increasing the weight and maintaining the inherent flexibility of the polymers.

The foregoing has outlined rather broadly the features of the present invention in order that the detailed description of the invention that follows may be better understood. Additonal features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically depicts the solvent-free functionalization of carbon nanotubes;

FIG. 2 schematically depicts the functionalization of individual SWNTs coated with SDS;

FIG. 3 illustrates an AFM analysis of functionalized material obtained by spin-coating a DMF solution onto a mica surface, wherein (A) is a height image and (B) is an amplitude image of aryl bromide functionalized nanotubes;

FIG. 4 illustrates a TEM image of (A) washed and filtered SWNTs, and (B) washed and filtered t-butyl aryl functionalized nanotubes showing that after functionalization, the tubes remain as individuals with little propensity to re-rope;

FIG. 5 depicts a Raman spectra (780.6 nm excitation) of (A) filtered SDS wrapped SWNT, (B) aryl chloride functionalized nanotubes 1, and (C) the functionalized nanotubes 1 after TGA (650° C., Ar) showing the recovery of the pristine SWNTs;

FIG. 6 schematically depicts the functionalization of SWNTs in accordance with at least one embodiment of the present invention;

FIG. 7 depicts stress vs. strain curves for a SWNT-PDMS composite (A) and a PDMS control (B), wherein the composite is seen to possess a significantly higher modulus;

FIG. 8 depicts normalized tensile modulus and elongation at break for compositions of SWNT wt %; and

FIG. 9 schematically depicts the functionalization of SWNTs in accordance with at least another embodiment of the present invention.

### DETAILED DESCRIPTION

The present invention is directed to carbon nanotube-elastomer composites, methods for making such carbon nanotube-elastomer composites, and articles of manufacture made with such carbon nanotube-elastomer composites. In general, such carbon nanotube-elastomer (CNT-elastomer) composites display an enhancement in their tensile modulus and toughness (over the native elastomer), but without a large concomitant reduction in their strain-at-break. Furthermore, in some embodiments, in addition to possessing enhanced mechanical properties, such resulting CNT-elastomer composites may also have enhanced thermal and/or electrical properties.

While the making and/or using of various embodiments of the present invention are discussed below, it should be appreciated that the present invention provides many applicable inventive concepts that may be embodied in a variety of specific contexts. The specific embodiments discussed herein are merely illustrative of specific ways to make and/or use the invention and are not intended to delimit the scope of the invention.

In general, the methods of the present invention comprise the steps of: 1) mixing carbon nanotubes with an elastomeric precursor (i.e., a polymer capable of becoming an elastomer upon curing or vulcanization), and 2) crosslinking the mixture to make a composite and/or blend of carbon nanotubes in an elastomeric material.

Curing, according to the present invention, entails effecting crosslinking within an elastomeric precursor so as to produce a “rubber-like” product. Vulcanization is a type of thermal curing.

Carbon nanotubes (CNTs), according to the present invention, include, but are not limited to, single-wall carbon nanotubes (SWNTs), multi-wall carbon nanotubes (MWNTs), double-wall carbon nanotubes, buckytubes, fullerene tubes, tubular fullerenes, graphite fibrils, and combinations thereof. Such carbon nanotubes can be made by any known technique induding, but not limited to, arc discharge [Ebbesen, Annu. Rev. Mater. Sci. 1994, 24:235-264], laser oven [Thess et al., Science 1996, 273:483-487], flame synthesis [Vander Wal et al., Chem. Phys. Lett. 2001, 349:178-184], gas-phase synthesis [U.S. Pat. No. 5,374,415], wherein a supported [Hafner et al., Chem. Phys. Lett. 1998, 296:195-202] or an unsupported [Cheng et al., Chem. Phys. Lett. 1998, 289:602-610; Nikolaev et al., Chem. Phys. Lett. 1999, 313:91-97] metal catalyst may also be used, and combinations thereof. Depending on the embodiment, the CNTs can be subjected to one or more processing steps prior to subjecting them to the mixing of the present invention. In some embodiments, the CNTs are separated based on a property selected from the group consisting of chirality, electrical conductivity, thermal conductivity, diameter, length, number of walls, and combinations thereof. See O'Connell et al., Science 2002, 297:593-596; Bachilo et al., Science 2002, 298:2361-2366; Strano et al., Science 2003, 301:1519-1522. In some embodiments, the CNTs have been purified. Exemplary purification techniques include, but are not limited to, those by Chiang et al. [Chiang et al., J. Phys. Chem. B 2001, 105:1157-1161; Chiang et al., J. Phys. Chem. B 2001, 105:8297-8301]. In some embodiments, the CNTs have been cut by a cutting process. See Liu et al., Science 1998, 280:1253-1256; Gu et al., Nano Lett. 2002, 2(9):1009-1013. The terms “CNT” and “nanotube” are used synonymously herein.

In some embodiments, the CNTs are chemically modified. Such chemical modification can include functionalization (derivatizafion) of the sidewalls and/or ends of the CNTs with funcfionalizing agents. Typically, such functionalization involves covalent attachment of functional groups to the CNTs and can be carried out by any suitable and known technique. Typical functional groups include, but are not limited to, phenyl groups, substituted phenyl groups, alkyl, hydroxyl, carboxyl, sulfonic acid, hydroxyalkyl, alkoxy, alkenyl, alkynyl, and combinations thereof, directly bound to the CNT or bound via some alkyl spacer moiety. In some embodiments, the chemical modification facilitates dispersal of the CNTs (especially SWNTs) and/or mixing in the elastomeric precursor. In these or other embodiments, the functionalization may provide chemical and/or physical interaction with the elastomer matrix.

Suitable elastomeric precursors (systems) include, but are not limited to, poly(dimethylsiloxane) and other polysiloxanes, polyisoprene, polybutadiene, polyisobutylene, halogenated polyisoprene, halogenated polybutadiene, halogenated polyisobutylene, low-temperature epoxy, ethylene propylene diene mononomer (EPDM) terpolymers, polyacrylonitriles, acrylonitrile—butadiene rubbers, styrene butadiene rubbers, ethylene propylene and other α-olefin copolymer based elastomers, tetrafluoroethylene based, copolymers of hexafluoropropylene and vinylidene fluoride, perfluoro methyl vinyl ethers and combinations thereof Elastomers and their precursors may generally be referred to as “polymers” herein.

Mixing of the CNTs with elastomeric precursors can be done by one or more of a variety of techniques and/or operations. Such techniques include, but are not limited to, mechanical stirring, shaking, solvent blending followed by solvent removal, twin-screw blending, calendaring, pounding, compounding, and combinations thereof. Such mixing may be carried out at one or more temperatures in the range of about 20° C. to about 400° C., and for a duration in the range of about 1 second to about 3 days. In some embodiments, the mixing is done under a pre-defined atmosphere or environment, in some cases involving one or more inert gases, and at one or more pressures in the range of about 0.01 Torr to about 1000 Torr.

In some embodiments, the CNTs and the elastomer precursor are mixed in a solvent. Suitable solvents include, but are not limited to, o-dichlorobenzene (ODCB), tetrahydrofuran (THF), N,N-dimethylformamide (DMF), water, chloroform, N-methylpyrrolidone (NMP), acetone, methyl ethyl ketone (MEK), dichloromethane, toluene, and combinations thereof. In some embodiments, a surfactant may be used to facilitate dispersion in a solvent or directly into the polymer host. In such embodiments, the CNTs are said to be “surfactant-wrapped.” Such surfactants can be ionic (cationic, anionic or zwitterionic) or non-ionic. A commonly used surfactant is sodium dodecylsulfate (SDS). In some embodiments, a technique such as sonication (i.e., ultra- or mega-) is employed to disperse one or both of the CNTs and the elastomeric precursor. In some embodiments, vacuum drying is used as a means of removing the solvent after mixing. Such vacuum drying can involve pressures in the range of about 0.0001 mm Hg to about 760 mm Hg, and temperatures in the range of about 20° C. to about 400° C. In additional or other embodiments, the nanotubes are precipitated and removed from the solvent.

In some embodiments, CNT functionalization and/or solvent choice is selected so as to provide for enhanced mixing in such solvents.

In some embodiments, CNTs (modified or unmodified via functionalization, surfactant wrapping, or other means) are dispersed in a solvent, and the elastomeric precursor is carefully selected and added to the dispersion so as to stabilize the dispersion. For example, amine-terminated isoprene or PDMS could be used.

Generally, the amount (i.e., wt %) of carbon nanotubes in the CNT-elastomer composite corresponds in a profound manner to the properties the CNT-elastomer composite has. Nevertheless, the amount of CNT in the composite system can generally be described as being in the range of about 0.001 wt % to about 20 wt %. These amounts, however, are highly dependent upon the type of CNTs used, and on any chemical modification and/or processing the CNTs have undergone. It is also dependent upon the elastomeric system employed.

In some embodiments, other additives are added to the mixture to refine or enhance the composite/blend properties, or to impart them with new or additional ones. Such other additives can include, but are not limited to, flame retardants, colorants, anti-degradation agents, antibacterial agents, plasticizors, reinforcers including other nanoscale or microscale fillers, UV stablizers, antioxidants, and combinations thereof.

Curing the mixture to effect crosslinking can also occur Within a broad range and variety of process parameters depending on the particular embodiment. In some embodiments, one or more curing agents are used. In some embodiments, a curing catalyst is used. In some embodiments, the curing process is thermally activated or enhanced. Generally, crosslinking comprises one or more temperatures in the range of about 50° C. to about 250° C., one or more pressures in the range of about 1 Torr to about 760 Torr, and durations in the range of about 1 second to about 1 day. Inert or oxidizing environments may be employed depending upon the particular embodiment, In some embodiments, this curing is effected by other thermal (e.g., heat lamp), radiative (e.g., microwaves, ions, electrons, ultraviolet light), or chemical means (e.g., acid, base, radical initiators). Generally, crosslink densities of the resulting CNT-elastomer composite are in the range of about 0.01 to about 5%.

In some embodiments, the composite Is molded into a desired shape. Generally, this is done simultaneously with the step of curing, but could also be carried out prior to curing or with partial curing. Such molding generally involves a transfer process by which the uncured material is transferred to the mold.

Generally, the resulting CNT-elastomer composites of the present invention have a 100-1000% increase in their tensile modulus and a 2 to 100 fold increase in the toughness relative to the native elastomer, but with a decrease in the strain-at-break of less than 50%.

In some embodiments, SWNTs are used as the CNT component of the CNT-elastomer composite. In some cases, the unique properties of SWNTs can impart the resulting composite with otherwise unattainable properties.

The equilibrium nanoscale dispersion of SWNTs in a polymeric matrix is generally dictated by the thermodynamic interactions between the organic and inorganic components. Largely defect-free SWNTs derive their unique combination of properties (described above) from their highly organized, near ideal sp²-bonded carbon structure. SWNTs have a relatively inert surface and a high cohesive energy density, resulting in a well-ordered collection of nanotubes in bundles or ropes that are hard to disperse even in low molecular weight solvents, however they are easier to disperse in their “as prepared” state than in their purified state. However, the dispersion of small quantities of SWNTs in low molecular solvents and polymerizable monomers has been demonstrated [Bahr J L, Tour J M: “Highly functionalized carbon nanotubes using in situ generated diazonium compounds,” Chem Mater 2001, 13:3823; Bahr J L, Yang J P, Kosynkin D V, Bronikowski M J, Smalley R E, Tour J M: “Functionalization of carbon nanotubes by electrochemical reduction of aryl diazonium salts: A bucky paper electrode,” JACS 2001, 123:6536-6542.; Bahr J L, Mickelson E T, Bronikowski M J, Smalley R E, Tour J M: “Dissolution of small diameter single-wall carbon nanotubes in organic solvents?” Chemical Communications 2001, 193-194; Ausman K D, Piner R, Lourie O, Ruoff R S, Korobov M: “Organic Solvent Dispersions of Single-Walled Carbon Nanotubes: Toward Solution of Pristine Nanotubes,” J. Phys. Chem. B 2000, 104:8911-8915].

While not Intending to be bound by theory, SWNTs have been considered as being analogous to rigid rod polymers. It is well established that mixtures of rod-like molecules and athermal solvents and mixtures of rod-like molecules and athermal flexible polymers can undergo “entropic demixing” beyond a critical volume fraction (φ_{r,c}), which to a first approximation is given as [Ballauff M, Dorgan J R: Fundamentals of Blends of Rigid-Chain (Liquid Crystal) Polymers. In Polymer Blends Volume 1: Formulation. Edited by Paul D R, Bucknall C B: John Wiley & Sons, Inc.; 2000:187-217, vol 1]:

$${ϕ}_{r , c} \approx \frac{8}{{x}_{r}} ( 1 - \frac{2}{{x}_{r}} )$$

where, xᵣ is the axial ratio of the rigid rod. Thus, at low concentrations, athermal solutions of rod-like molecules are isotropic, while at concentrations higher than φ_{r,c,} the system is nematic. On the basis of theoretical calculations, the order parameter S, defined as:
S=1−1.5<Sin ψ>
where ψ is the angle between a rod and the preferred axis, is ˜0.9 at the transition. The finite persistence length of the rod-like molecules and the interactions among the rod-like molecules leads to a lower value of S at the transition (0.3-0.4) without altering the location of the transition.

Given the experimental and theoretical work involving rod-like molecules and polymer coils, the overall picture that emerges is summarized as follows. Mixtures of rod-like and random coil polymers phase separate in the absence of strong intermolecular interactions between the components [Arnold J F E, Arnold F E: “Rigid Rod Polymers and Molecular Composites,” Adv. Polym. Sci. 1994, 117:257-295]. The incorporation of strong ionic interactions or hydrogen bonding between the constituents leads to the formation of thermodynamically stable nanoscopically mixed systems. The properties of such nanoscopically mixed systems are considerably different from those of the pure components—in some cases leading to lyotropic behavior, in other cases leading to considerable enhancement of physical and mechanical properties, and in still other cases causing the fracture mechanism to be completely altered. The addition of articulated branches to the rod-like molecules leads to a significant lowering of rod aggregation and in some cases dramatic increases in tensile strength [Bai S J, Dotrong M, Evers R C: “Bulk rigid-rod molecular composites of articulated rod copolymers with thermoplastic pendants,” J. Polym. Sci.:Part B: Polym. Phys. 1992, 30:1515-1525].

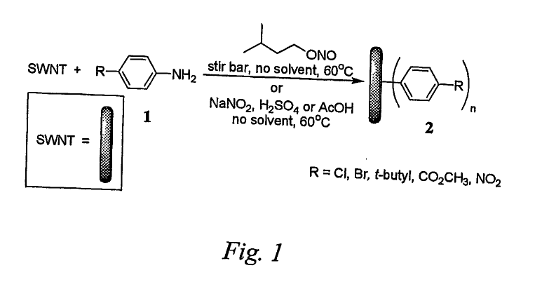

In light of the above considerations, for their full potential to be realized, generally high degrees of SWNT sidewall functionalization must be achieved, thereby generating compounds that are more compatible with composites and are more soluble [Reich S, Maultzsch J, Thomsen C, Ordejon P: “Tight-binding description of graphene,” Physical Review B 2002, 66; Girifalco L A, Hodak M: “Van der Waals binding energies in graphitic structures,” Physical Review B 2002, 65; Girifalco L A, Hodak M, Lee R S: “Carbon nanotubes, buckyballs, ropes, and a universal graphitic potential,” Physical Review B 2000, 62:13104-13110]. The electrochemical reduction of diazonium salts [Bahr J L, Yang J P, Kosynkin D V, Bronikowski M J, Smalley R E, Tour J M: “Functionalization of carbon nanotubes by electrochemical reduction of aryl diazonium salts: A bucky paper electrode,” JACS 2001, 123:6536-6542] and thermally-generated diazonium compounds will readily functionalize SWNTs [Bahr J L, Tour J M: “Highly functionalized carbon nanotubes using in situ generated diazonium compounds,” Chem Mater 2001, 13:3823]. However, a severe limitation of all CNT functionalization processes thus far has been the extraordinary amounts of solvent needed (˜2 L/g coupled with sonication in most cases) for the dissolution or dispersion of the SWNTs. Solvent-free functionalizations have been developed (See FIG. 1), that avoid the use of solvent for functionalization, form very few side-products, and can be used to introduce a wide variety of organic functionality onto the sidewall (and possibly the end) of the carbon nanotube during the functionalization protocol [Tanaka K, Toda F: “Solvent-free organic synthesis,” Chemical Reviews 2000, 100:1025-1074; Dyke C A, Tour J M: “Solvent-free functionalizaton of carbon nanotubes,” Journal of the American Chemical Society 2003, 125:1156-1157]. Referring to FIG. 1, SWNTs are reacted with a substituted aniline 1 in the presence of an organic nitrate to yield functionalized SWNTs 2. This methodology produces functionalized nanotubes thereby leading the way for large-scale functionalization of the materials and providing a fundamentally different approach when considering reaction chemistry on these unique materials. Not only does this solvent-free methodology overcome reaction solubility and scale concerns, but it also offers the added advantages of being cost-effective and environmentally benign. The reaction has been conducted on multi-gram quantities of carbon nanotubes thereby supplying the amount of nanotubes required for structural materials applications.

In many of the various embodiments of the present Invention utilizing functionalized CNTs, the above-mentioned solvent-free method is utilized to provide functionalized CNTs (although other methods can be used). The solvent-free method, in particular, has made functionalization industrially feasible since it permits the large-scale functionalization, even in situ (if desired) in a twin-screw blender by adding the nanotubes, aniline, and a nitrite. In some embodiments, after a short residence time, polymer can be added, and the inorganic byproducts can be left in the polymer blend. The functionalization groups are not eliminated from the nanotubes, to any significant extent, until a temperature in the range of 280-400° C., well above the working range of the targeted applications. For example, downhole oilfield applications generally peak at ˜150° C. and may rise to 190° C. only in the extreme.

The above-described solvent-free process is not limited to SWNTs. The solvent-free process also works on MWNTs. See Dyke C A, Tour J M: “Solvent-free functionalization of carbon nanotubes,” Journal of the Amencan Chemical Society 2003, 125:1156-1157. This is advantageous because the chemistry of MWNTs is believed to be far more limited than for SWNTs.

Another technique employed to overcome the insolubility of carbon nanotubes, in accordance with the present invention, is the functionalizaton of individualized SWNTs [Dyke C A, Tour J M: “Unbundled and highly functionalized carbon nanotubes from aqueous reactions,” Nano Letters 2003, 3:1215-1218]. In the above discussion of solvent-free techniques, bundles of nanotubes, treated with reactive reagents, are mechanochemically exfoliated. In that case, as well as in most other functionalization reports, what results are functionalized bundles or mixtures of nanotubes functionalized to various degrees. However, dispersing carbon nanotubes as individuals prior to a functionalizafion reaction delivers individual functionalized carbon nanotubes. Although not initially applicable to large-scale transformations, it is of fundamental scientific significance for the generation of SWNTs that are incapable of tube-tube re-roping; they clearly overcome the inherent thermodynamic intermolecular cohesive drive (0.5 eV per nanometer) to re-bundle.

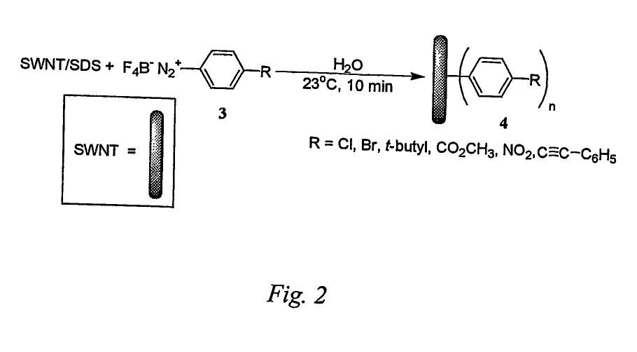

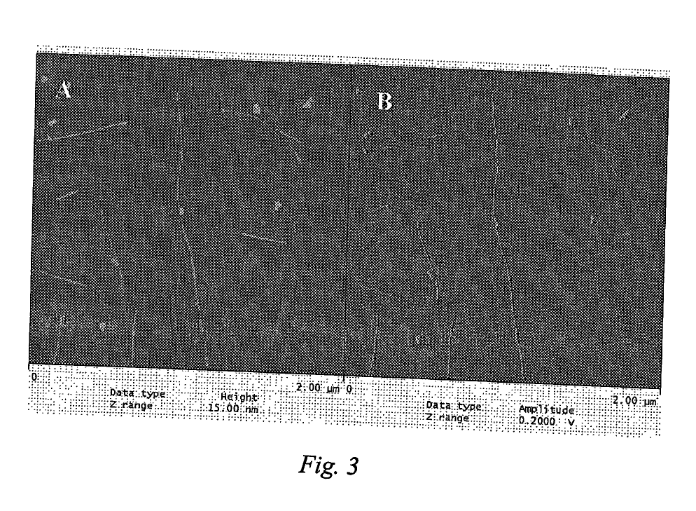

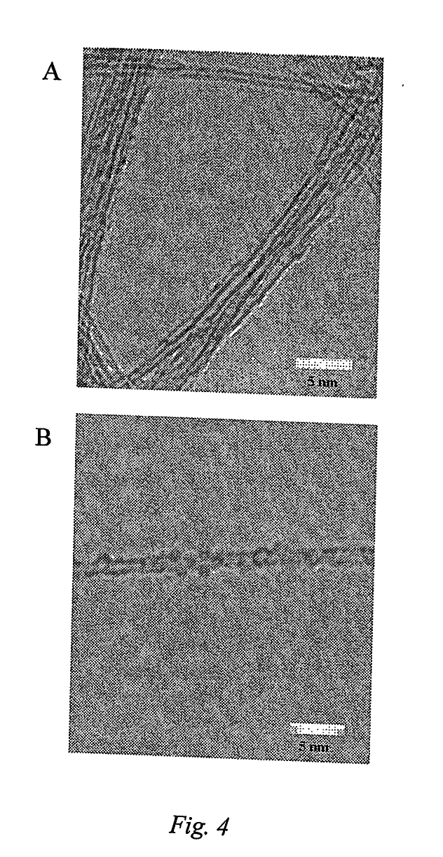

Functionalization reactions involving individual CNTs have been demonstrated by reacting HiPco-produced SWNTs (Carbon Nanotechnologies Inc., Houston, Tex.), that were wrapped in sodium dodecylsulfate (SDS), with a-diazonium species [Strano M S, Dyke C A, Usrey M L, Barone P W, Allen M J, Shan H W, Kittrell C, Hauge R H, Tour J M, Smalley R E: “Electronic structure control of single-walled carbon nanotube functionalization,” Science 2003, 301:1519-1522; Dyke C A, Tour J M: “Unbundled and highly functionalized carbon nanotubes from aqueous reactions,” Nano Letters 2003, 3:1215-1218]. Referring to FIG. 2, functionalization of these stable suspensions of SDS-wrapped SWNTs (SWNT/SDS) with diazonium salts 3 yields heavily-functionalized SWNTs 4 with greatly increased solubility in a variety of solvents. Interestingly, this material 4 disperses as individual SWNTs in organic solvent even after removal of the surfactant, which is clearly evident from atomic force microscopy (AFM) and transmission electron microscopy (TEM) analyses. Referring to FIG. 3, AFM analysis reveals a height image (A) and an amplitude image (B) of aryl bromide functionalized nanotubes spun-coated from a DMF solution onto a freshly-cleaved mica surface. The unfunctionalized (pristine) material bundles after removal of the surfactant; however, the nanotubes that are functionalized as individuals disperse as individuals in organic solvent. Referring to FIG. 4, TEM image (A) reveals washed and filtered (to remove SDS) SWNTs, whereas TEM image (B) shows washed and filtered t-butyl aryl functionalized nanotubes, wherein it is seen that the tubes remain as individuals with little propensity to re-rope. The ability to separate the different tube types using this approach of selective functionalization would permit the conductivity of the blends to be variable. While some embodiments of the present invention provide for functionalization of CNTs individually dispersed In a surfactant system, others involve functionalization of CNTs dispersed in intercalating acids [Hudson, J. L.; Casavant, M. J. Tour, J. M. “Water Soluble, Exfoliated, Non-Roping Single Wall Carbon Nanotubes,” J. Am. Chem. Soc., submitted]. Such intercalating acids include, but are not limited to, oleum, methanesulfonic acid, and combinations thereof. These individualized (unroped or unbundled) CNT may give enhanced properties over the functionalized ropes.

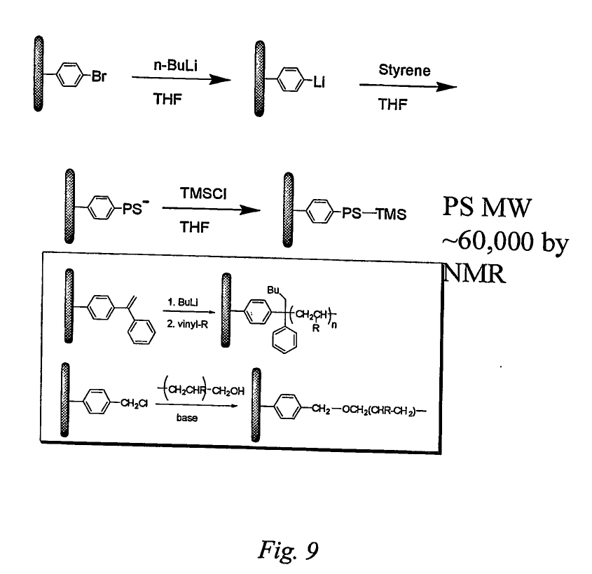

FIG. 9 reflects another method by which polymerization is conducted off of the CNT bundles or individuals from the addends. [See PCT Patent Application, entitled “Polymerization Initiated at the sidewalls of carbon nanotubes” to Tour et al, filed Jun. 21, 2004 (Attorney Docket No. 11321-P068WO), co-owned by Assignee of the present Application]. In this way the CNTs can be the point of origin for a polymer chain that either matches the host elastomer type in that case similar molecular weight of the addends to the blend could help to overcome entropy of mixing problems) or have addends that mix well with the blend material for enthalpic rather than entropic reasons. In the resulting material, there need not even be a blend host—every nanotube could be the graft point for multiple elastomeric segments.

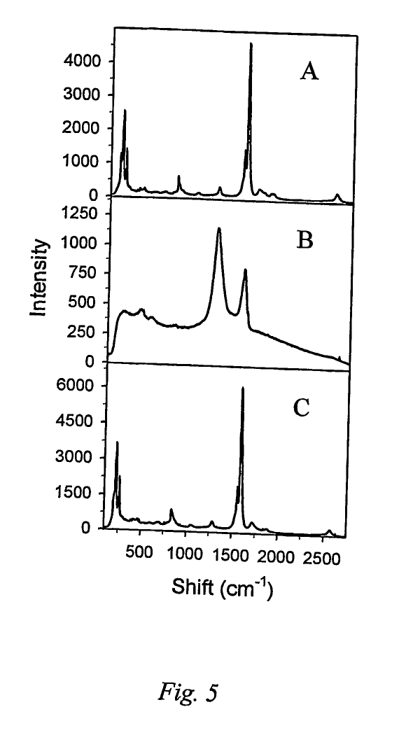

In some embodiments, Raman spectroscopy is used to characterize the functionalized CNTs. Referring to FIG. 5, Raman spectroscopy (780.6 nm excitation) can be used to verify that the material is functionalized as individuals, wherein (A) is the spectrum of filtered SWNTs/SDS, (B) is aryl chloride functionalized SWNTs 4, and (C) is functionalized nanotube 4 after TGA (650° C., Ar) showing the recovery of the pristine SWNTs. Clearly, the material is highly functionalized as evidenced by the disorder mode being larger in intensity than the tangential mode [Dyke C A, Tour J M: “Unbundled and highly functionalized carbon nanotubes from aqueous reactions,” Nano Letters 2003, 3:1215-1218]. This further underscores that functionalized CNTs could be used for enhancing blending, followed by heating of the blend to remove the CNT-pendants, thereby regenerating the optical and electronic properties of the starting CNTs. Heating to 350-400° C. is generally sufficient.

Thus, CNTs can be compatabilized with polymer matrices by chemically modifying the nanotubes to establish favorable interactions between the tubes and the polymer matrix. While others exist, some efficient mechanisms for functionalization of nanotubes are as illustrated in FIGS. 1 and 2, described above. While not intending to be bound by theory, theoretical calculations have suggested that the outstanding tensile properties arise from the formation of reversible topological defects (such as a double pentagon-heptagon pair) allowing for plastic deformation of the nanotubes [Yakabson B I, Campbell M P: “High strain rate fracture and C-chain unraveling in carbon nanotubes,” Computational Materials Science 1997, 8:341-348; Wagner H D: “Nanotube-polymer adhesion: a mechanics approach,” Chemical Physics Letters 2002, 361:57-61; Fisher F T, Bradshaw R D, Brinson L C: “Effects of nanotube waviness on the modulus of nanotube—reinforced polymers,” Appiled Physics Letters 2002, 80:4647-4649]. On the other hand, the superior compressive properties (unlike those of graphite fibers that fracture under compression) likely arise from the ability of nanotubes to form kink-like ridges under compression that can relax elastically after unloading. While functionalization of the tubes must introduce topological defects along the sidewall of the tubes, the finite persistence length associated with the tubes in their pristine form [Sano M, Kamino A, Okamura J, Shinkai S: “Ring closure of carbon nanotubes,” Science 2001, 293:1299-1301] would dominate the properties and the introduction of additional defects would only be a perturbation to the conformations of the SWNTs.

In summary, the present invention provides CNT-elastomer composites combining the unique properties of CNTs, and especially SWNTs, with those of elastomers, while maintaining low density and high strain-at-break. Other nanoparticles such as layered silicates can provide similar low density and high strain-at-break but do not possess the extraordinary mechanical, thermal and electrical properties that CNTs can provide.

The following examples are provided to more fully illustrate some of the embodiments of the present invention. It should be appreciated by those of skill in the art that the techniques disclosed in the examples which follow represent techniques discovered by the inventors to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

### EXAMPLE 1

This Example serves to illustrate how an elastomer can be reinforced with functionalized single-walled carbon nanotubes (SWNTs) to provide a high strength CNT-elastomer composite with a high breaking strain and a low density. The resulting material, produced with 0.7 wt % of functionalized SWNTs, exhibits a three fold increase in the tensile modulus while retaining a strain-at-break of 6.5, a number almost identical to the un-reinforced (native) system. These results are noteworthy because, while additives can be applied within elastomers to make them have a higher tensile modulus (stiffness), they generally cause a concomitant large reduction in the strain-at-break. The optimal effect occurred at about 4 wt % addition where you see approximately 8-fold increase in the modulus with almost no change in the strain-at-break

In this Example, crosslinked elastomers comprising functionalized SWNTs were prepared using amine terminated poly(dimethylsiloxane) (PDMS) with weight average molecular weight of 5,000 daltons, Crosslink densities, estimated on the basis of swelling data in toluene, indicated that the polymer underwent crosslinking at the ends of the chains. This crosslinking was thermally initiated and found to occur only in the presence of the aryl alcohol functionalized SWNTs. The crosslinking could have been via a hydrogen-bonding mechanism between the amine and the free hydroxyl group, or via attack of the amine on the ester linkage to form an amide. Tensile properties examined at room temperature indicated three fold increase in the tensile modulus of the elastomer, with rupture and failure of the elastomer occurring at a strain of 6.5.

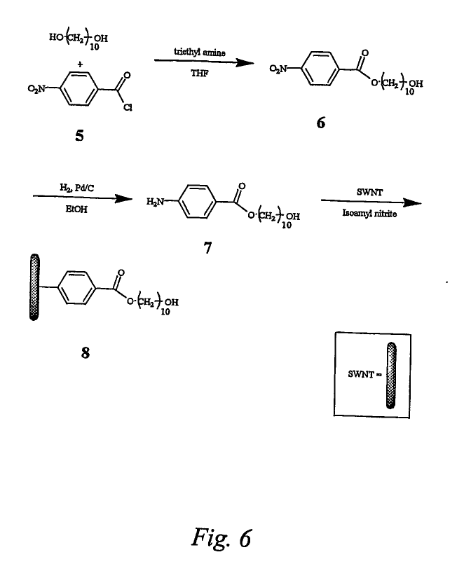

Specifically, crosslinked samples of an amine-terminated polydimethylsiloxane (M_{w}˜5000, Aldrich) with aryl-substtuted nanotubes (with alcohol terminus) (see FIG. 6) were performed at 170° C. in a heated press after initial degassing in a vacuum oven overnight at 120° C. The functionalized SWNT sample used was prepared according to the protocol described in Dyke, C. A.; Tour, J. M. “Solvent-Free Functionalizafion of Carbon Nanotubes,” J. Am. Chem. Soc., 2003, 125:1156-1157. Referring to FIG. 6, compound 5 is reacted with a dialcohol to yield 6, which is then hydrogenated to yield substituted aniline 7, which then reacts with SWNTs in the presence of isoamyl nitrite to yield functionalized SWNTs 8. During the thermal cure, the samples were subjected to a forces of 1 ton and continuously subject to vacuum. Control samples of crosslinked PDMS were prepared using a vinyl terminated PDMS (M_{w}˜5000, HULS) and crosslinked with TEOS. Crosslink densities for the two samples were found within measurement errors to be similar based on swelling in toluene and hexane.

### EXAMPLE 2

This Example serves to illustrate how an elastomer can be reinforced with pristine (unfunctionalized) single-walled carbon nanotubes. Hydroxyl terminated PDMS with tetraethyl orthosilicate (TEOS) as crosslinker was used to prepare the networks. Two different molecular weight samples (7 k and 20 k with PDI of ˜2) were used. SWNT was added to the PDMS as powder (or flakes) and a vast excess of toluene added and the mixture stirred for several hours (and in some cases days). The sample was then freeze-dried and allowed to completely dry in a vacuum oven overnight at 35° C. For the blanks (i.e., no SWNTs) this step was avoided.

The amount of TEOS added was calculated to achieve a ratio of cross-linker functionality to hydroxyl chain ends that was optimized to be ˜1.3 times that required by stoichiometry and physically added to the PDMS-SWNT mixtures. Stannous 2-ethylhexanoate was added as catalyst and added at a level of 0.75 g/100 g of chains (for 20 k) and 1.5 g/100 g of chains (for 7 k) of polymer. This mixture was sufficiently stirred for 1 hour. In some cases, where the SWNT was in excess of 1 wt % the samples were too viscous to be stirred and toluene was added to the samples to lower the viscosity. Care was taken In this case to not add the catalyst until the mixture was almost ready to be processed for solvent removal. The solvent was removed rapidly by flashing and the mixture allowed to stir while keeping the sample dark and at a temperature <25° C. The samples were then transferred to glass scintillation vials and allowed to cure using the following temperature profile in a vacuum oven:
a. 35° C. under vacuum for 1 hour (sample should thicken considerably); Otherwise hold for an additional 2 hours
b. Raise T to 75° C. (under vacuum) and hold for 12 hours.
c. Raise T to 170° C. (under vacuum) and hold for 2 hours.
   The samples could then be removed from the vials, typically by breaking the vials.

In some cases, Applicants have discovered problems with glass scintillation vials and have followed an alternative procedure, wherein steps a and b use a polypropylene vial. The sample does not adhere to PP and can be easily removed. It is then transferred to either a glass or quartz holder and final cured at 170° C.

Additionally, in at least one case, Applicants have observed some phase separation as soon as stirring was stopped. To compensate for this, the initial slow cure was carded out at 35° C. for 6 hours while keeping the sample stirred and under a light vacuum. After this, steps b and c, without the stirring, were performed with a strong vacuum in an oven.

### EXAMPLE 3

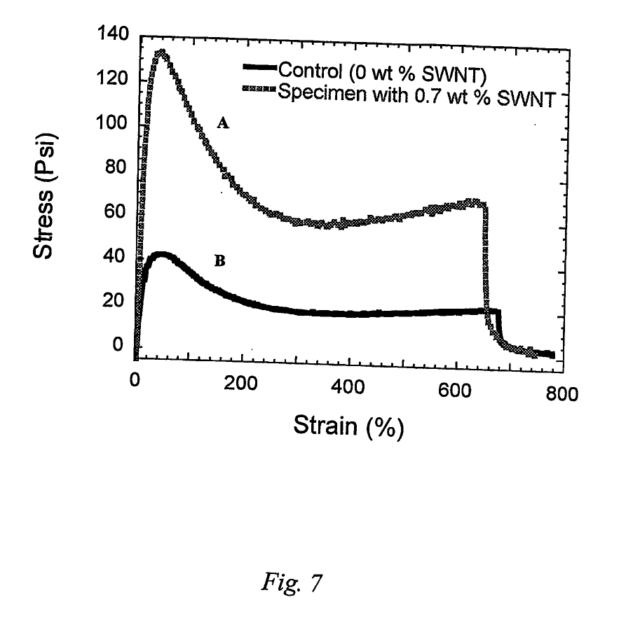

Tensile stress-strain measurements were performed on three micro-dumbbell specimens, prepared by molding in a high-temperature press with vacuum suction applied to the specimen holders, at a test temperature of 25° C. and an Instron cross-head speed of 0.5″/min. The data shown in FIG. 7 illustrate the significantly higher modulus of the SWNT based PDMS elastomer as compared to the control sample with no SWNT. Moreover, the strains-at-break for the two samples are comparable. Based on a total of six samples for the nanocomposites and the unfilled elastomer:

$$\frac{{Y}_{nano}}{{Y}_{control}} = 3.2 \pm 0.2$$

$${ɛ}_{nano}^{break} = 630 \pm 20 \%$$

$${ɛ}_{Control}^{break} = 670 \pm 25 \%$$

where Yₙₐₙₒ and Y_{control} are the tensile modulus estimated based on the linear behavior at low strain values for the nanocomposite and the control sample respectively, and εₙₐₙₒ^{break} and ε_{control}^{break} are the values of the strain-at-break for the nanocomposite and the control sample respectively.

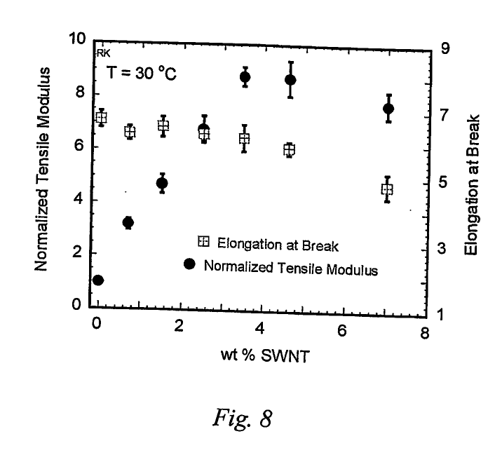

FIG. 8 shows normalized tensile modulus and elongation at break for compositions of SWNT wt % and reflects the resulting CNT-elastomer composites of the present invention have a 100-1000% increase in their tensile modulus and 3-1000 fold increase in the toughness, relative to the native elastomer, but with a decrease in the strain-at-break of less than 50%.

Although the demonstration here is only for PDMS, the technique should work for a wide range of elastomers and a wide range of functional nanotubes. It is not restricted to the system shown here. They key is having these long nanotube structures linked within the elastomer matrix. It will likely also work with multi-walled carbon nanotubes.

All patents and publications referenced herein are hereby incorporated by reference. It will be understood that certain of the above-described structures, functions, and operations of the above-descrbed embodiments are not necessary to practice the present invention and are included in the description simply for completeness of an exemplary embodiment or embodiments. In addition, it will be understood that specific structures, functions, and operations set forth in the above-described referenced patents and publications can be practiced In conjunction with the present invention, but they are not essential to its practice. It is therefore to be understood that the invention may be practiced otherwise than as specifically described without actually departing from the spirit and scope of the present invention as defined by the appended claims.

What is claimed is:

1. A method comprising the steps of:
a) functionalizing CNTs to form functionalized CNTs;
b) mixing the functionalized CNTs with an elastomeric precursor to form a mixture; and
c) curing the mixture to form a CNT-elastomer composite.

2. The method of claim 1, wherein the functionalized CNTs are functionalized on their sidewalls.

3. The method of claim 1, wherein the CNTs are single-wall carbon nanotubes.

4. The method of claim 1, wherein the step of functionalizing comprises a reaction between CNTs and at least one diazonium species.

5. The method of claim 4, wherein the reaction between the CNTs and the at least one diazonium species is a solvent-free process.

6. The method of claim 4, wherein the CNTs are dispersed as individuals prior to reacting them with the diazonium species.

7. The method of claim 6, wherein the CNTs are dispersed as individuals with the aid of a surfactant.

8. The method of claim 6, wherein the CNTs are dispersed as individuals in an intercalating acid medium.

9. The method of claim 8, wherein the intercalating acid medium is oleum.

10. The method of claim 1, wherein the step of mixing is carried out in a solvent.

11. The method of claim 10, wherein the solvent is removed after mixing via vacuum drying.

12. The method of claim 1, wherein the step of mixing is carried out in a blending apparatus.

13. The method of claim 1, wherein the step of mixing is carried out for a duration of from about 1 second to about 3 days.

14. The method of claim 1, wherein the step of mixing is carried out at a temperature of from about 20° C. to about 400° C.

15. The method of claim 1, wherein the amount of functionalized CNTs mixed with the elastomeric precursor is from about 0.01 weight percent to about 30 weight percent of the weight of the resulting composite.

16. The method of claim 1, wherein the elastomeric precursor is selected from the group consisting of poly(dimethylsiloxane), polyisoprene, polybutadiene, polyisobutylene, halogenated polyisoprene, halogenated polybutadiene, halogenated polyisobutylene, low-temperature epoxy, nitrile polymers such as polyacrylonitrile, fluoropolymers, EPDM terpolymers, and combinations thereof.

17. The method of claim 1, wherein the step of curing effects a crosslinking within the composite matrix.

18. The method of claim 1, wherein the step of curing comprises a curing process selected from the group consisting of thermal curing, radiative curing, chemical curing, and combinations thereof.

19. The method of claim 1, wherein the step of curing involves a curing agent.

20. The method of claim 1, wherein the step of curing involves a curing catalyst.

21. The method of claim 1, wherein the step of curing involves a curing temperature of from about 80° C. to about 200° C.

22. The method of claim 1, wherein the step of curing involves a curing pressure of from about 1 Torr to about 760 Torr.

23. The method of claim 1, wherein the step of curing is carried out in an inert atmosphere.

24. The method of claim 1 further comprising a step of reacting the functionalized CNTs with the elastomer so as to covalently integrate the CNTs into the elastomeric matrix.

25. A method comprising the steps of:
a) surfactant-wrapping CNTs to form surfactant-wrapped CNTs;
b) mixing the surfactant-wrapped CNTs with an elastomeric precursor to form a mixture; and
c) curing the mixture to form a CNT-elastomer composite.

26. The method of claim 25, wherein the CNTs are single-wall carbon nanotubes.

27. The method of claim 25, wherein the step of mixing is carried out in a solvent.

28. The method of claim 27, wherein the solvent is removed after mixing via vacuum drying.

29. The method of claim 25, wherein the step of mixing is carried out in a blending apparatus.

30. The method of claim 25, wherein the step of mixing is carried out for a duration of from about 1 second to about 3 days.

31. The method of claim 25, wherein the step of mixing is carried out at a temperature of from about 20° C. to about 400° C.

32. The method of claim 25, wherein the amount of surfactant-wrapped CNTs mixed with the elastomeric precursor is from about 0.001 weight percent to about 20 weight percent of the total weight of the resulting composite.

33. The method of claim 25, wherein the elastomeric precursor is selected from the group consisting of poly(dimethylsiloxane), polyisoprene, polybutadiene, polyisobutylene, halogenated polyisoprene, halogenated polybutadiene, halogenated polyisobutylene, low-temperature epoxy, EPDM terpolymers, and combinations thereof. Add nitriles and fluoro

34. The method of claim 25, wherein the step of curing effects a crosslinking within the composite matrix.

35. The method of claim 25, wherein the step of curing comprises a curing process selected from the group consisting of thermal curing, radiative curing, chemical curing, and combinations thereof.

36. The method of claim 25, wherein the step of curing involves a curing agent.

37. The method of claim 25, wherein the step of curing involves a curing catalyst.

38. The method of claim 25, wherein the step of curing involves a curing temperature of from about 80° C. to about 200° C.

39. The method of claim 25, wherein the step of curing involves a curing pressure of from about 1 Torr to about 760 Torr.

40. The method of claim 25, wherein the step of curing is carried out in an inert atmosphere.

41. A method comprising the steps of:
a) dispersing CNTs in a solvent to form a dispersion;
b) adding elastomeric precursor to the dispersion to form a mixture;
c) removing the solvent from the mixture to form a blend; and
d) curing the blend to form a CNT-elastomer composite.

42. The method of claim 41, wherein the CNTs are single-wall carbon nanotubes.

43. The method of claim 41, wherein the solvent is selected from the group consisting of ODCB, DMF, THF, and combinations thereof.

44. The method of claim 41, wherein the elastomeric precursor is selected from the group consisting of poly(dimethylsiloxane), polyisoprene, polybutadiene, polyisobutylene, halogenated polyisoprene, halogenated polybutadiene, halogenated polyisobutylene, low-temperature epoxy, EPDM terpolymers, and combinations thereof.

45. The method of claim 41, wherein the elastomeric precursor comprises functionality to enhance interaction with the CNTs.

46. The method of claim 41, wherein the solvent is removed by a method selected from the group consisting of filtration, precipitation, evaporation, and combinations thereof.

47. The method of claim 41, wherein the step of curing comprises a curing process selected from the group consisting of thermal curing, radiative curing, chemical curing, and combinations thereof.

48. The method of claim 41, wherein the step of curing involves a curing agent.

49. The method of claim 41, wherein the step of curing involves a curing catalyst.

50. The method of claim 41, wherein the step of curing involves a curing temperature of from about 80° C. to about 200° C.

51. The method of claim 41, wherein the step of curing involves a curing pressure of from about 1 Torr to about 760 Torr.

52. The method of claim 41, wherein the step of curing effects a crosslinking within the composite matrix.

53. The method of claim 41, wherein the step of curing is carried out in an inert atmosphere.

54. A CNT-elastomer composite comprising functionalized CNTs in an elastomeric matrix.

55. The CNT-elastomer composite of claim 54, wherein the tensile modulus of the composite is 100-1000% greater than the native elastomer has a stain-at-break that is comparable to the native elastomer.

56. The CNT-elastomer composite of claim 55, wherein the CNT-elastomer composite has a stain-at-break that is comparable to the native elastomer.

57. The CNT-elastomer composite of claim 55, wherein the CNT-elastomer composite has a stain-at-break that is within 50% of the value of the native elastomer.

58. The CNT-elastomer composite of claim 54, wherein the CNTs are present in the composite in an amount that is from about 0.001 weight percent to about 20 weight percent.

59. The CNT-elastomer composite of claim 54, wherein the CNTs are covalently bound to the elastomeric matrix through functional groups attached to their sidewalls.

60. The CNT-elastomer composite of claim 54, wherein the CNTs are covalently bound to the elastomeric matrix through functional groups attached to their ends.

61. The CNT-elastomer composite of claim 54, wherein the CNTs are covalently bound to the elastomeric matrix through functional groups attached to their sidewalls and ends.

62. The CNT-lastomer composite of claim 54, wherein the CNTs interact with the elastomeric matrix via a mechanism selected from the group consisting of hydrogen bonding, van der Waals bonding, pi-pi interactions, dipolar interactions, acid-base interactions, and combinations thereof.

63. The CNT-elastomer composite of claim 54, wherein the elastomeric matrix is cured polymeric precursor selected from the group consisting of poly(dimethylsiloxane), polyisoprene, polybutadiene, polyisobutylene, halogenated polyisoprene, halogenated polybutadiene, halogenated polyisobutylene, low-temperature epoxy, EPDM terpolymers, and combinations thereof.

64. The CNT-elastomer composite of claim 54 further comprising at least one additional component selected from the group consisting of colorants, anti-degradation agents, plasticzers, and combinations thereof.

65. The CNT-elastomer composite of claim 54, wherein the CNTs are single-wall carbon nanotubes.

66. The CNT-elastomer composite of claim 54, wherein the CNTs are functionalized on their sidewall.

67. The CNT-elastomer composite of claim 54, wherein the CNT-elastomer composite has enhanced physical properties in addition to enhanced mechanical properties, wherein the additional enhanced properties are selected from the group consisting of electrical properties, mechanical properties, and combinations thereof.

68. The CNT-elastomer composite of claim 54, wherein the composite has a crosslink density of from about 0.01% to about 5%.
